(19) United States
(12) Patent Application Publication
(10) Pub. No.: US 2004/0230717 A1
(43) Pub. Date: Nov. 18, 2004

(54) Processing device

(76) Inventors: Terunobu Funatsu, Chiyoda (JP); Kazuhiro Umekita, Tsuchiura (JP); Yoshihiro Sakakibara, Ryugasaki (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/742,750

(22) Filed: Dec. 23, 2003

(30) Foreign Application Priority Data
Apr. 18, 2003 (JP) 2003-113558

(51) Int. Cl. G06F 13/28

(52) U.S. Cl. 710/22

(57) ABSTRACT

An upstream processor unit of a processing device has a memory, a processor, a memory access controller and a transmission unit. A downstream processor unit has a memory, a processor and a reception unit. A host processor unit, the processors and the memory access controller can gain access to the memory of the upstream processor unit, while the host processor unit, the processors and the reception unit can gain access to the memory of the downstream processor unit. The reception unit has a FIFO memory.

### BACKGROUND OF THE INVENTION

The present invention relates to a processing device for transmitting data among processors.

An example of a conventional processing device is disclosed in JP-A-5-274279. In the processing device disclosed in page 16 and FIG. 8 of the publication, FIFO (first in, first out) memories for data transmission and data reception are provided in a transmitter-side processor and a receiver-side processor respectively in order to improve the data transmission rate and efficiency between the processors. Then, the effective data transmission rate between the processors is improved due to the connection between the memories. Further, memories using an alternating buffer technique for reception are provided in the receiver-side processor so that the data received from the receiving FIFO memory is transferred to one of the receiving buffer memories in a DMA (Direct Memory Access) mode. In addition, a buffer memory to be a transfer destination of DMA data transfer from the FIFO memory is alternated every processing phase so that the throughput of the processor is prevented from deteriorating due to the interprocessor data transfer.

In JP-A-5-274279, satisfactory consideration is not given to the case where data in a memory a plurality of processors gain access to is transmitted efficiently to another memory a plurality of processors gain access to.

### BRIEF SUMMARY OF THE INVENTION

The present invention was developed in consideration of such a problem in the related art. It is an object of the present invention to transmit data in a memory a plurality of processors gain access to, to another memory efficiently.

In order to attain the foregoing object, the present invention provides a processing device in which a host processor unit is connected with first and second processor units through a common bus. In the processing device, each of the first and second processor units includes a processor for performing processing, a memory for storing data to be processed by the processor, first and second communication interfaces for receiving data to be processed by the processor from another processor unit or transferring the data to another processor unit, and a DMA controller for controlling data transfer between the memory and the first and second communication interfaces, and the first communication interface of the second processor unit includes a first reception unit having a FIFO memory so that data stored in the memory of the first processor unit can be transferred to the memory of the second processor unit.

In this configuration, preferably, the processor and the DMA controller belonging to the processor unit the memory belongs to and the host processor unit are connected to the memory so that the processor, the DMA controller and the host processor unit can gain access to the memory. In addition, it is preferable that the second communication interface of the first processor unit has a second reception unit having a FIFO memory so that data stored in the memory of the second processor unit can be transferred to the memory of the first processor unit. Further, it is preferable that data in a transfer source memory, an address of a transfer destination memory and an amount of data to be transferred are transferred as a packet when the DMA controller transfers the data from the transfer source memory to the transfer destination memory through the FIFO memory, the transfer source memory belonging to the processor unit the DMA controller belongs to, the transfer destination memory belonging to another processor unit.

In the aforementioned configuration, more preferably, a register provided for the processor unit can store an address of a transfer source memory, an address of a transfer destination memory, an amount of data to be transferred and a transfer start flag, while the DMA controller belonging to the processor unit the processor belongs to supplies a transfer end signal to the processor. Alternatively, a register provided for the processor unit can store an address of a transfer source memory, an address of a transfer destination memory, an amount of data to be transferred, a transfer start flag and a transfer end flag.

Further, a transmission unit may be provided in each of the second communication interfaces of the first and second processor units so that a packet transmitted to the FIFO memory belonging to the reception unit of the first communication interface of the second processor unit is transferred to the transmission unit belonging to the second communication interface of the second processor unit if an address of a transfer destination memory transmitted to the FIFO memory is not an address of the memory belonging to the second processor unit when data is transferred from the memory of the first processor unit to the reception unit of the first communication interface of the second processor unit. Alternatively, a transmission unit may be provided in each of the second communication interfaces of the first and second processor units so that a packet transmitted to the FIFO memory belonging to the reception unit of the second communication interface of the first processor unit is transferred to the transmission unit belonging to the first communication interface of the first processor unit if an address of a transfer destination memory transmitted to the FIFO memory is not an address of the memory belonging to the first processor unit when data is transferred from the memory of the second processor unit to the reception unit of the second communication interface of the first processor unit. In addition, a shared memory may be connected to the processors belonging to the first and second processor units.

The aforementioned object can be attained by another configuration of the present invention. That is, the invention also provides a processing device having a plurality of processor units connected to a host processor unit through a common bus. In the processing device, each of the plurality of processor units includes a processor for performing data processing, a memory for storing data to be processed by the processor, first and second communication interfaces for receiving data to be processed by the processor from another processor unit or transmitting the data to another processor unit, and a DMA controller for controlling data transfer between the memory and the first and second communication interfaces, and each of the first and second communication interfaces includes a transmission unit and a reception unit having a FIFO memory. The processor, the DMA controller and the host processor unit are connected to the local memory so that the processor, the DMA controller and the host processor unit can gain access to the memory. Thus, data stored in the memory of one processor unit can be transferred to the memory of another processor unit.

### BRIEF DESCRIPTION OF THE SEVERAL VIEWS OF THE DRAWING

FIG. 1 is a block diagram showing an embodiment of a processing device according to the present invention;

FIG. 2 is a view showing an area inside a register of the processing device;

FIG. 3 is a diagram showing an example of a packet diagram with a timing chart in the processing device; and

FIG. 4 is a diagram showing another example of a packet diagram with a timing chart in the processing device.

### DETAILED DESCRIPTION OF THE INVENTION

An embodiment of the present invention will be described below with reference to the drawings.

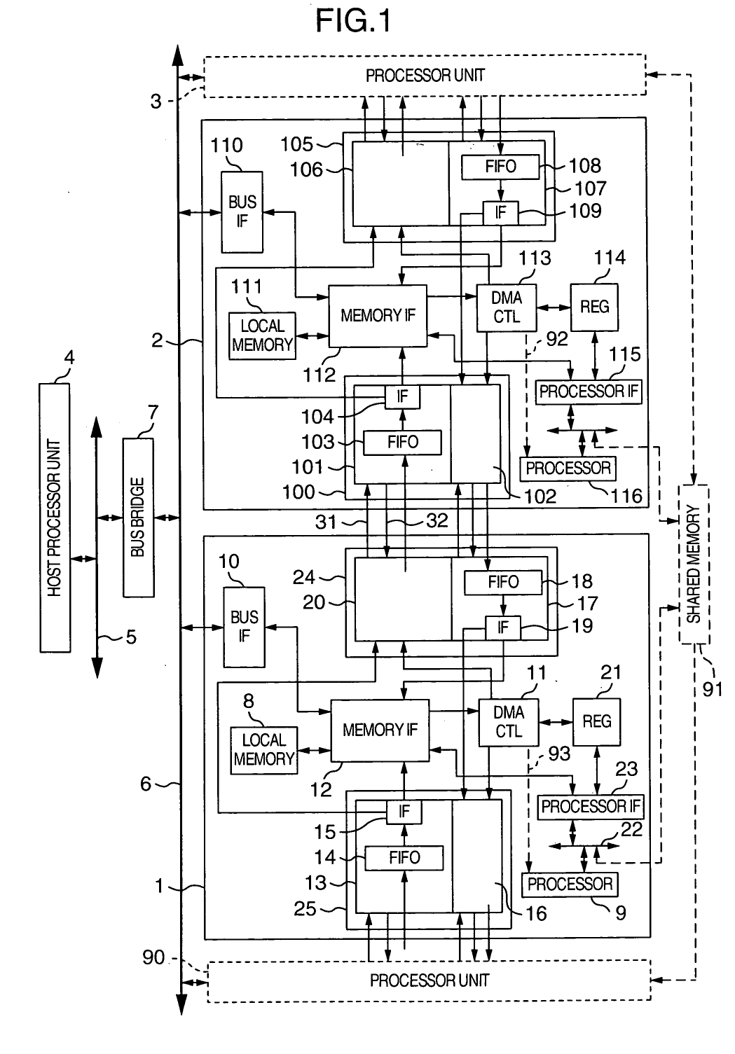

FIG. 1 is a block diagram of an embodiment of a processing device according to the present invention. A processing device 50 has two upstream and downstream processor units 1 and 2 performing processing and connected to a bus 6, and a host processor unit 4 connected to a bus 5. The bus 6 the upstream and downstream processor units 1 and 2 are connected to and the bus 5 the host processor unit 4 is connected to are connected through a bus bridge 7.

The upstream processor unit 1 includes a processor 9 connected to a bus 22, a memory 8, a DMA controller 11, a register 21, a memory interface 12, a first communication interface 24 and a second communication interface 25. The first communication interface 24 is provided with a transmission unit 20 and a reception unit 17 having a FIFO memory 18. The second communication interface 25 is provided with a transmission unit 16 and a reception unit 13 having a FIFO memory 14.

The memory interface 12 is connected to the memory 8, a processor interface 23, a bus interface 10, the DMA controller 11, an interface 19 provided in the reception unit 17 of the first communication interface 24, and an interface 15 provided in the reception unit 13 of the second communication interface 25 and connected to the transmission unit 20. The DMA controller 11 is connected to the transmission unit 20 of the first communication interface 24, the transmission unit 16 of the second communication interface 25, and the register 21.

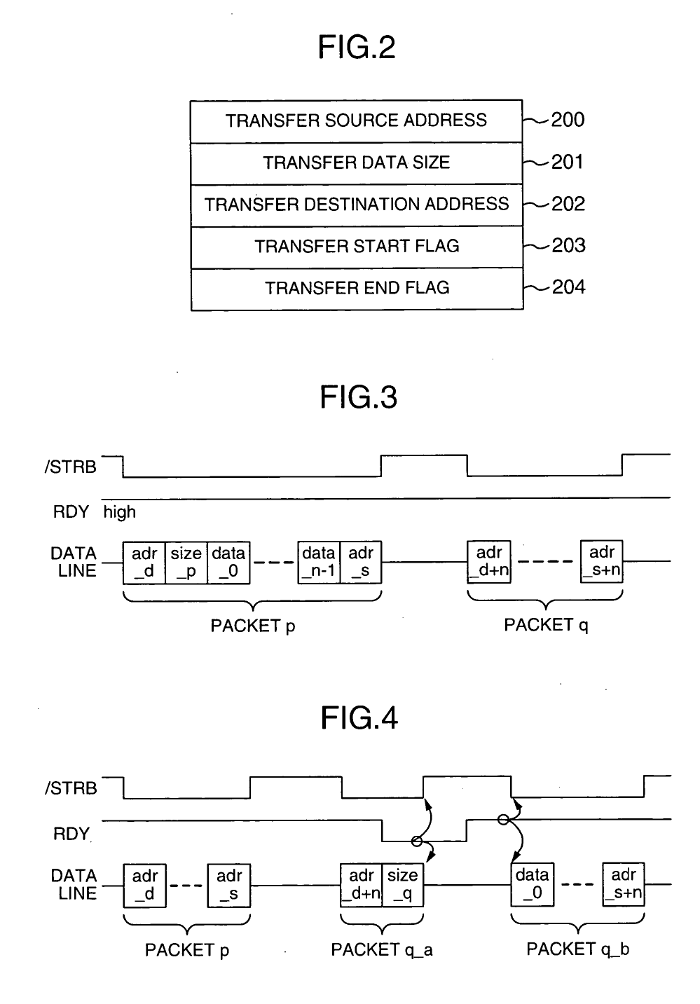

The processor interface 23 is connected to the bus 22, the register 21 and the memory interface 12. Areas of a transfer source address 200, a transfer data size 201, a transfer destination address 202, a transfer start flag 203 and a transfer end flag 204 are provided in the register 21, as shown in detail in FIG. 2.

The downstream processor unit 2 is configured in the same manner as the upstream processor unit 1. That is, the downstream processor unit 2 includes a processor 116, a memory 111, a DMA controller 113, a register 114, a memory interface 112, a first communication interface 105, a second communication interface 100, a processor interface 115 and a bus interface 110.

The first communication interface 105 is provided with a transmission unit 106 and a reception unit 107 having a FIFO memory 108 and an interface 109. The second communication interface 100 is provided with a transmission unit 102, and a reception unit 101 having a FIFO memory 103 and an interface 104.

The upstream processor unit 1 and the downstream processor unit 2 are connected as follows. The transmission unit 20 provided in the first communication interface 24 of the upstream processor unit 1 is connected to the reception unit 101 and the FIFO memory 103 provided in the second communication interface 100 of the downstream processor unit 2.

The reception unit 17 provided in the first communication interface 24 of the upstream processor unit 1 is connected to the transmission unit 102 provided in the second communication interface 100 of the downstream processor unit 2. The FIFO memory 18 provided in the reception unit 17 is also connected to the transmission unit 102 provided in the second communication interface 100 of the downstream processor unit 2.

As shown by the broken lines in FIG. 1, a processor unit 3 and a processor unit 90 having the same function as the upstream processor unit 1 may be also attached to the processing device 50 configured thus. When the processor units 3 and 90 are added, the downstream processor unit 2 and the processor unit 3 are connected in the same manner as the upstream processor unit 1 and the downstream processor unit 2 are connected. The processor unit 90 and the upstream processor unit 1 are connected in the same manner as the upstream processor unit 1 and the downstream processor unit 2 are connected.

The operation of this embodiment configured thus will be described below. To gain access to the memory 8 of the upstream processor unit 1, the host processor unit 4 gains access to the bus bridge 7. Next, the host processor unit 4 gains access to the memory 8 through the bus 6, the bus interface 10 connected to the bus 6, and the memory interface 12 connected to the bus interface 10.

On the other hand, the processor 9 in the upstream processor unit 1 gains access to the memory 8 through the processor interface 23 and the memory interface 12 in turn, so that data in a predetermined area of the memory 8 can be transferred to the memory 111 in the adjacent downstream processor unit 2. This operation will be described below.

Once the transfer start flag 203 in the register 21 connected to the processor interface 23 turns active, data transfer is started. On the other hand, as soon as the data transfer is terminated, the transfer end flag 204 in the register 21 turns active. The number of data to be transferred is stored in the area of the transfer data size 201. The processor 9 checks the transfer end flag 204 and the transfer start flag 203 in the register 21. Only when the transfer end flag 204 is active and the transfer start flag 203 is inactive, the processor 9 recognizes the status as transferable, and advances to a transfer start sequence. When the upstream processor unit 1 is not in the transferable status, the processor 9 checks the transfer end flag 204 and the transfer start flag 203. Then, the processor 9 does not perform transfer processing till the status becomes transferable.

The processor 9 writes the address 200 of the transfer source memory 8 belonging to the upstream processor unit 1, the size (amount) 201 of data to be transferred, and the address 202 of the transfer destination memory 111 belonging to the downstream processor unit 2, into the register 21. At the same time, the processor 9 sets the transfer start flag 203 active.

When the transfer start flag 203 in the register 21 belonging to the upstream processor unit 1 turns active, the DMA controller 11 makes the transfer end flag 204 in the register 21 inactive. After that, a packet p shown in detail in FIG. 3 is generated. The generated packet p is sent to the reception unit 101 of the second communication interface 100 belonging to the downstream processor unit 2 via the transmission unit 20 of the first communication interface 24. When the packet p has been sent, the DMA controller 11 makes the transfer start flag inactive.

The packet p includes a transfer destination address adr_d, a transfer data size size_p, transfer data data_0 to data_n−1, and a transfer source address adr_s. The DMA controller 11 generates the packet p as follows. The DMA controller 11 generates the transfer destination address adr_d with reference to the transfer destination address 202 in the register 21. Likewise, the DMA controller 11 generates the transfer source address adr_s with reference to the transfer source address 200 in the register 21.

When the number of data to be transferred by the packet p is n, the transfer data size size_p is (n+3). The DMA controller 11 further reads data corresponding to the transfer data size size_p from the address of the memory 8 corresponding to the transfer source address adr s via the memory IF 12, and generates the transfer data data_0 to data_n−1.

The packet p generated and sent by the DMA controller 11 is sent to the reception unit 101 of the second communication interface 100 together with a strobe signal (/STRB) 30 by the transmission unit 20 of the first communication interface 24. The strobe signal 30 is active when the packet p is sent from the transmission unit 20 to the reception unit 101. FIG. 3 shows an example of the timing chart of the strobe signal 30.

Here, the strobe signal 30 is set as a low active signal which is active when the signal is low. A ready signal (RDY) 31 shown in FIG. 3 is a signal sent from the reception unit 101 to the DMA controller 11 via the transmission unit 20. Only when the ready signal 31 is active, the reception unit 101 can receive the packet p sent from the DMA controller 11 via the transmission unit 20. In FIG. 3, the ready signal 31 is set as a high active signal.

When the transfer capacity B for the packet p is too low to send data corresponding to the data number A set in the transfer data size 201, the DMA controller 11 creates a subsequent packet q in the same manner as the packet p. Thus, the remaining data that cannot be sent in the packet p is sent as the packet q to the transmission unit 20 of the first communication interface 24. The transmission unit 20 also sends the packet q to the reception unit 101 belonging to the downstream processor unit 2 in the same manner as the packet p. Incidentally, a transfer destination address adr_d+n of the packet q generated by the DMA controller 11 is set at an address following the transfer destination address of the transfer data data_n−1 transferred by the packet p. A transfer source address adr_s+n of the packet q is set at an address following the transfer source address of the transfer data data_n−1 transferred by the packet p.

When the number of data to be transferred by the packet q is n, the transfer data size size_q of the packet q is (n+3) as large as that of the packet p. To send the number of data set in the transfer data size 201, the transfer data size size_q of the packet q is set at (m=A—B) when the number of data to be sent by the packet q is m smaller than n.

When all the data set in the transfer data size 201 are sent to the reception unit 101 by the packet q, the DMA controller 11 sets the transfer end flag 204 active. Of the data set in the transfer data size 201, there may be data that cannot be sent to the reception unit 101 by the packet q. In such a case, the DMA controller 11 creates a subsequent packet r in the same manner as the packet q, and sends the packet r to the reception unit 101. The same sequence is repeated till all the data corresponding to the number set in the transfer data size 201 are sent to the reception unit 101.

Each piece of information of the packet p sent to the reception unit 101 belonging to the second communication interface 100 of the downstream processor unit 2 is written into the FIFO memory 103 in the reception unit 101. The interface 104 belonging to the reception unit 101 reads the packet p in the FIFO memory 103. At that time, when the transfer destination address adr_d designates an address of the memory 111 in the downstream processor unit 2, the transfer data size size_p and the transfer data data_0 to data_n−1 are read from the FIFO memory 103. After that, the transfer data data_0 to data_n−1 are written into the memory 111 in turn with the transfer destination address adr_d as a start address.

When the transfer destination address adr_d does not designate any address of the memory 111, the interface 104 in the reception unit 101 sends the packet p to the transmission unit 106 belonging to the first communication interface 105. The transmission unit 106 has a circuit for arbitrating between the access from the interface 104 and the access from the DMA controller 113. The transmission unit 106 transmits the packet p to a not-shown reception unit of the further downstream processor unit 3. The transmission unit 20 has a function similar to that of the transmission unit 106. Thus, the contents of the memory 8 can be transferred to a memory (not shown) in the processor unit 3.

When the FIFO memory 103 is full of data so that a signal sent from the transmission unit 20 cannot be written therein, the reception unit 101 sets the ready signal 31 inactive. When the ready signal 31 is inactive, the strobe signal 30 is set inactive to abort sending any packet though the packet should be sent from the transmission unit 20 to the reception unit 101. FIG. 4 shows an example of such a timing chart in which packets are sent.

Assume that the ready signal 31 turns inactive in the course of sending the packet q. In this case, after a packet q_a which is a part of the packet q is sent, sending the packet is suspended till the ready signal 31 turns active again. Then, when the ready signal 31 turns active again, a packet q_b which is the remaining part of the packet q is sent.

The reception unit 17 of the first communication interface 24 has substantially the same configuration as the reception unit 101 of the second communication interface 100. The transmission unit 102 of the second communication interface 100 has substantially the same configuration as the transmission unit 20 of the first communication interface 24. In addition, the second communication interface 25 has substantially the same configuration as the first communication interface 24.

The memory interface 12 has an arbiter. This arbiter arbitrates accesses to the memory 8 from the host processor unit 4, the processor 9, the DMA controller 11, the first communication interface 24 and the second communication interface 25. In the arbitration of the arbiter, each access source may be treated equally, or priority may be given to the access from the processor 9. When priority is given to the access from the processor 9, the access from the processor 9 to the memory 8 is preferred to any other access to the memory 8. Thus, when the processor 9 is performing critical processing, the processing is carried out in preference.

According to this embodiment, not only the processor 9 but also the host processor unit 4 and the DMA controller transferring memory data in another processor unit can gain access to the memory 8. Thus, data written by any access source can be transferred to a memory in any other processor unit. In addition, according to this embodiment, each processor unit has first and second communication interfaces each including a transmission unit and a reception unit together. Thus, data transfer can be performed bidirectionally. Further, data transfer and processing in each processor can be performed in parallel. As a result, parallel processing can be performed efficiently by use of a plurality of processors.

When the transfer data size size_p, size_q, . . . of each packet is not larger than the capacity of the FIFO memory 103, data can be transferred efficiently. The reason is just as follows. Assume that there occurs a request to transfer a packet from the memory 8 to the memory 111 when the transfer data size of the packet is not larger than the capacity of the FIFO memory 103. Then, all the data of the packet transferred from the memory 8 by the DMA controller 11 can be once written into the FIFO memory 103. Even when the interface 104 is waiting to write the data of a packet into the memory 111, for example, for such a reason that the processor 116 is in access to the memory 111, the DMA controller 11 can send the packet to the second communication interface 100 without waiting. The larger the capacity of the FIFO memory 103 is, the more effective it is.

Although the processor 9 is notified of the end of data transfer by the change of the transfer end flag 204 in the register 21 in the aforementioned embodiment, the DMA controller 11 can use an interrupt signal 93 to notify the processor 9. In this case, the processor 9 can be notified of the end of data transfer while carrying on another processing without checking the transfer end flag 204.

In addition, a shared memory 91 to which each processor 9, 116 provided in each processor unit 1, 2, 3, 90 can gain access may be provided. When the shared memory 91 is provided, data communication can be established among the processors using the shared memory 91 if the data is random access data. When the data is not random access data, the data is transferred, for example, in the method shown in the aforementioned embodiment. Since two transfer paths can be formed in accordance with kinds of data, data can be transferred more efficiently among the processor units.

According to the present invention, a FIFO memory is provided in a reception unit in a DMA transfer path so that data can be stored temporarily in the FIFO memory. It is therefore possible to transfer data without suspending any access from the DMA controller and processors. Accordingly, data in a memory a plurality of processors gain access to can be transferred efficiently to another memory a plurality of processors gain access to. Thus, parallel processing can be carried out efficiently using a plurality of processors.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A processing device comprising:
a host processor unit;
first and second processor units;
a common bus connecting said host processor unit with said first and second processor units;
each of said first and second processor units including:
a processor for performing processing;
a memory for storing data to be processed by said processor;
first and second communication interfaces for receiving data to be processed by said processor from another processor unit or transmitting said data to another processor unit; and
a DMA controller for controlling data transfer between said memory and said first and second communication interfaces;
said first communication interface of said second processor unit including a first reception unit having a FIFO memory so that data stored in said memory of said first processor unit can be transferred to said memory of said second processor unit.

2. A processing device according to claim 1, wherein the processor and the DMA controller belonging to the processor unit said memory belongs to and said host processor unit are connected to said memory so that said processor, said DMA controller and said host processor unit can gain access to said memory.

3. A processing device according to claim 2, wherein the second communication interface of said first processor unit has a second reception unit having a FIFO memory so that data stored in the memory of said second processor unit can be transferred to the memory of said first processor unit.

4. A processing device according to claim 2, wherein data in a transfer source memory, an address of a transfer destination memory and an amount of data to be transferred are transferred as a packet when said DMA controller transfers said data from said transfer source memory to said transfer destination memory through said FIFO memory, said transfer source memory belonging to the processor unit said DMA controller belongs to, said transfer destination memory belonging to another processor unit.

5. A processing device according to claim 3, wherein data in a transfer source memory, an address of a transfer destination memory and an amount of data to be transferred are transferred as a packet when said DMA controller transfers said data from said transfer source memory to said transfer destination memory through said FIFO memory, said transfer source memory belonging to the processor unit said DMA controller belongs to, said transfer destination memory belonging to another processor unit.

6. A processing device according to claim 4, wherein a register provided in said processor can store an address of a transfer source memory, an address of a transfer destination memory, an amount of data to be transferred and a transfer start flag, and the DMA controller belonging to the processor unit said processor belongs to supplies a transfer end signal to said processor.

7. A processing device according to claim 4, wherein a register provided in said processor can store an address of a transfer source memory, an address of a transfer destination memory, an amount of data to be transferred, a transfer start flag and a transfer end flag.

8. A processing device according to claim 4, wherein a transmission unit is provided in each of the second communication interfaces of said first and second processor units, and a packet transmitted to said FIFO memory belonging to the reception unit of the first communication interface of said second processor unit is transferred to the transmission unit belonging to the second communication interface of said second processor unit if an address of a transfer destination memory transmitted to said FIFO memory is not an address of the memory belonging to said second processor unit when data is transferred from the memory of said first processor unit to the reception unit of the first communication interface of said second processor unit.

9. A processing device according to claim 4, wherein a transmission unit is provided in each of the second communication interfaces of said first and second processor units, and a packet transmitted to said FIFO memory belonging to the reception unit of the second communication interface of said first processor unit is transferred to the transmission unit belonging to the first communication interface of said first processor unit if an address of a transfer destination memory transmitted to said FIFO memory is not an address of the memory belonging to said first processor unit when data is transferred from the memory of said second processor unit to the reception unit of the second communication interface of said first processor unit.

10. A processing device according to claim 4, wherein a shared memory is connected to the processors belonging to said first and second processor units.

11. A processing device according to claim 5, wherein a register provided in said processor can store an address of a transfer source memory, an address of a transfer destination memory, an amount of data to be transferred and a transfer start flag, and the DMA controller belonging to the processor unit said processor belongs to supplies a transfer end signal to said processor.

12. A processing device according to claim 5, wherein a register provided in said processor can store an address of a transfer source memory, an address of a transfer destination memory, an amount of data to be transferred, a transfer start flag and a transfer end flag.

13. A processing device according to claim 5, wherein a transmission unit is provided in each of the second communication interfaces of said first and second processor units, and a packet transmitted to said FIFO memory belonging to the reception unit of the first communication interface of said second processor unit is transferred to the transmission unit belonging to the second communication interface of said second processor unit if an address of a transfer destination memory transmitted to said FIFO memory is not an address of the memory belonging to said second processor unit when data is transferred from the memory of said first processor unit to the reception unit of the first communication interface of said second processor unit.

14. A processing device according to claim 5, wherein a transmission unit is provided in each of the second communication interfaces of said first and second processor units, and a packet transmitted to said FIFO memory belonging to the reception unit of the second communication interface of said first processor unit is transferred to the transmission unit belonging to the first communication interface of said first processor unit if an address of a transfer destination memory transmitted to said FIFO memory is not an address of the memory belonging to said first processor unit when data is transferred from the memory of said second processor unit to the reception unit of the second communication interface of said first processor unit.

15. A processing device according to claim 5, wherein a shared memory is connected to the processors belonging to said first and second processor units.

16. A processing device comprising:
a host processor unit;
a plurality of processor units;
a common bus connecting said host processor unit with said processor units;
each of said plurality of processor units including:
a processor for performing data processing;
a memory for storing data to be processed by said processor;
first and second communication interfaces for receiving data to be processed by said processor from another processor unit or transmitting said data to another processor unit; and
a DMA controller for controlling data transfer between said memory and said first and second communication interfaces;
each of said first and second communication interfaces including a transmission unit and a reception unit having a FIFO memory, said processor, said DMA controller and said host processor unit being connected to a local memory so that said processor, said DMA controller and said host processor unit can gain access to said memory, with the result that data stored in the memory of one processor unit can be transferred to the memory of another processor unit.
